(19) United States
(12) Patent Application Publication
(10) Pub. No.: US 2004/0155863 A1
(43) Pub. Date: Aug. 12, 2004

(54) User interface device without imposing strain on eyesight

(75) Inventors: Katsumi Sakamaki, Ashigarakami-gun (JP); Kazuyuki Tsukamoto, Ashigarakami-gun (JP); Shin Takeuchi, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/722,453

(22) Filed: Nov. 28, 2003

(30) Foreign Application Priority Data
Nov. 29, 2002 (JP) 2002-348419
Nov. 26, 2003 (JP) 2003-394971

(51) Int. Cl. G09G 5/00

(52) U.S. Cl. 345/156

(57) ABSTRACT

An opening is formed on a display screen, through which an operation member of an operation switch device protrudes for operation. The operation switch device comprises a display control section for controlling image display and an operation member drive control section for controlling driving of the operation member based on an operation pattern which is predetermined so as to correspond to an image displayed. The operation member drive control section drives the operation member so that the operation member can be operated only in directions of selection items shown in the displayed image, that is, directions of the arrows A, B, C, and D relative to an original point. In this way, the user interface creates mechanical operating feeling with superior recognition without imposing strain on a user's eye sight.

### BACKGROUND OF THE INVENTION

1. Field of the Invention

The present invention relates to a user interface device and in particular to an improved user interface device for use in referencing an image shown on a display of an information processing device.

2. Description of the Related Art

For improved input operation, a Graphical User Interface, or GUI, has been widely employed in information processing devices. A GUI enables input operation using a mouse to move a mouse cursor on a GUI, in addition to input operation using a keyboard, or a conventional input means.

In addition, a touch panel method which allows for selection and/or switching through direct touch on a display screen, rather than using a mouse, has also been commonly used as an operation screen implemented in copying machines, printers, vehicle navigation systems, ticket vending machines, ATMs for financial institutions, and so forth. For a touch panel method, a display for image displaying covered by a transparent touch panel is most commonly used.

Other examples of conventional input means include a volume dial, such as is commonly used in audio devices, radios, and so forth, for physical rotation by a user to thereby change volume, and any mechanical structure, such as a toggle switch, for physical up/down movement of a lever to thereby achieve on/off switching. Although these are superior in recognition, these input means are becoming unpopular because of their large size, mono-functionality, and difficulty in modifying layout.

The above described operation, including an input operation, using a mouse relies on an object displayed on a GUI. In this operation, although associated functions and/or locational coordinate values of various selection buttons, that is, the displayed objects, may change as screen images are changed at, different stages of an input operation, the manner of operation remains the same, using only a mouse and clicking throughout the entire procedure. This is monotonous for the user, even though a cursor has been moved to different points and/or a single button is given different functions in different screen images. This may increase the likelihood of erroneous selection due to troublesome operation in moving a mouse cursor and misplacement of a mouse cursor.

A touch-panel method is an interface technique which allows information input by physically touching a screen, while looking at the screen, according to instructions displayed on the screen. Because a selection switch is located at substantially the same position as the associated object displayed, time and labor to move a cursor and/or occurrence of erroneous selection can be reduced. However, although a variety of kinds of methods are available for touch panels, including one which uses a thin resistive film and another which utilizes light shielding using infrared rays and light receiving elements, none of these kinds of touch-panel methods can create feeling of pressing down, or stroking feeling, in the operation.

Further, as reaction to an input operation is limited to change of an image, a touch-panel method is inferior in recognition compared to the above-mentioned mechanical structures. Still further, in the recent trend toward use of more detailed and multi-layered screen images for input menus, binary on/off selection with a touch panel method is disadvantageous in that it takes time to complete each operation and increases the number of layers in a structural hierarchy.

FIG. 18 shows an example of a conventional selection screen image used for copying machines. As it employs a touch-panel method, this selection screen image requires continuous pressing of a button to set a desired value for a zoom function, which may take time. Moreover, operating feeling which can be created using a touch-panel method is monotonous from a tactile point of view, and may not make the user to assure of the completion of an input operation.

In order to address these problems, Document 1 (Japanese Patent Laid-open Application No. Hei 10-289050) describes an information input device having a touch panel for use by visually handicapped people. The device has panels mounted to the right, left, top, and bottom of the touch panel, which have concave and convex graphical features having specific meanings. By touching this touch panel, the user can haptically know the functions of the respective buttons.

Document 2 (Japanese Patent Laid-open Application No. Hei 11-31438) describes a structure in which a separate switch having a deeper stroke is provided relative to a switch in a touch panel, outside the touch panel. As an input signal from the separate switch and an input signal from the switch in a touch panel are correlated to each other, operating the separate switch can produce an identical effect to that which would be produced by operating the switch in the touch panel. This can provide an advantage that operation of a switch can be confirmed through sense of touch.

Document 3 (Japanese Patent Laid-open Application No. 2001-113981) describes a vehicle display device which is characterized in that an information display section and an operation member are independently provided at separate locations. For example, an operation member may be provided on a steering wheel so that the driver can operate the device while keeping his or her eyes directed forward.

However, the structure of Document 1 (Japanese Patent Laid-open Application No. Hei 10-289050) in which functions of the buttons are expressed using fixed concave and convex features on the panel cannot readily accommodate a case in which the number of menu screens is increased and a single switch is given a multi-layered input mode. Thus, this structure is not suitable for general use.

Although the structure of Document 2 (Japanese Patent Laid-open Application No. Hei 11-31438) can enhance the capability of creating the operating feeling when a plurality of mechanical switches capable of producing stroking feeling are provided, use of these mechanical switches is limited to a simple function such as turning on/off as the switches are mono-functional mechanical switches. Another problem of this structure is such that the user must move his or her eyes in different directions when touching the button and when looking at the image on the touch panel.

FIG. 19 shows an example of conventional art exhibiting this problem. Specifically, FIG. 19 shows an image display section and operation switches implemented in a waveform observing apparatus such as measurement devices, medical devices, and so forth. In this example, required input conditions must be input following the text guidance shown in the displayed image in order to measure or observe waveforms. However, the image section and the operation switch section are located separately from each other, which is inconvenient for the user operating the operation switch section while looking at the image section. Moreover, as switch operation is often limited to a simple on/off function, each function requires an individual switch. This may result in the need for a larger number of switches.

Although the structure of Document 3 (Japanese Patent Laid-open Application No. 2001-113981) is optimum for use in an environment, such as while driving a vehicle, in which separation of display and operation is desired, this structure is not similarly optimum for use in copying machines, electric home appliances, portable phones, tool machines, information devices, medical devices, and so forth.

In view of the above, in order to reduce operational errors and strain on a user's eyesight, it is desirable to use the feature of a touch-panel method that a displayed image and the operation member are located close to each other so that the user can operate the operation member while looking at the screen image.

However, mere modification of a touch panel by providing auxiliary members or mechanical switches around a touch panel to compensate for the lack of reliable operating feeling created in an operation using a touch panel method is insufficient as such modified devices still cannot accommodate expected sophistication of a device, including more detailed and multi-layered image menus for multi-functional devices. Therefore, there is still a need for an interface device capable of overcoming the defective lack of operating feeling created in an operation using a touch-panel method while utilizing the above described superior feature and additionally accommodating multi-layered and detailed image menus.

### SUMMARY OF THE INVENTION

The present invention has been conceived in order to address the above-described problems and advantageously provide a user interface device which is superior in recognition and capable of producing mechanical operating feeling without increasing strain on a user's eyesight.

In order to achieve the above described object, according to one aspect of the present invention, there is provided a user interface device comprising a display screen for displaying an image; display control means for controlling so as to display an image on the display screen; an operation member for being operated by a user; and operation member drive control means for driving the operation member at least in one-dimensional direction. In this user interface device, the operation member may be mounted within, in the vicinity of, or partly overlapping a display region of the display screen.

Further, the operation member drive control means may drive the operation member according to an operation pattern which corresponds to the image displayed on the display screen.

Still further, the operation member drive control means may convey a variety of reactive forces to the user operating the operation member depending on the image displayed on the display screen.

Yet further, the user interface device of the present invention may further comprise position detection means for detecting a position of the operation member within the display screen. In this interface device, the operation member drive control means may change an operation pattern for the operation member according to the position of the operation member which is detected by the position detection means.

Yet further, the display control means may change an image to be displayed on the display screen according to the position of the operation member relative to the image displayed on the display screen.

Yet further, the display control means may switch images to be displayed on the display screen in response to an input confirmation operation performed by the user following the image displayed on the display screen.

Yet further, the operation member may have an input confirmation mechanism.

Yet further, the display control means may control so as to display a selection item selected by the user using the operation member from among a plurality of selection items displayed on the display screen, in a manner different from a manner of displaying other selection items.

Yet further, the operation member drive control means may drive the operation member in a non-display mode when no image is displayed on the display screen.

Yet further, the operation member may be provided within the display screen and connected through an opening formed on the display screen to the operation member drive control means provided below the display screen.

Yet further, the operation member and the operation member drive control means may be provided on the display screen.

Yet further, the display screen may additionally function as the operation member.

Yet further, the operation member drive control means may drive the operation member with at least two degrees of freedom.

Yet further, the operation member drive control means may drive the operation member with freedom along a plane in a two-dimensional direction which is substantially parallel to the display screen serving as a reference plane.

Yet further the operation member drive control means may drive the operation member with freedom for rotation around an axis in a first direction substantially parallel to the display screen serving as a reference plane, rotation around an axis in a second direction substantially parallel to the reference plane and vertical to the first direction, rotation around an axis in a third direction substantially vertical to the reference plane, or rotation that is a combination of at least two types of rotation described above.

Yet further, the screen display means may have a touch panel input mechanism.

Yet further, the user interface device of the present invention may further comprise detection means for detecting an amount of operation of the operation means. In this user interface device, the operation member drive control means may change an operation pattern for the operation member according to the amount of operation detected by the detection means.

According to the present invention, as an operation member is provided within the display screen, the user is allowed to operate the operation member while following a displayed image with less movement of his or her sight line. Therefore, as excessive strain is not imposed on the user's eyes while operating, erroneous operation can be reduced.

In addition, as an operation member drive control means is provided to the user interface device in order to drive an operation member, it is possible to create a reactive force in response to a user's operation so that the user can conceive operating feeling, such as clicking.

Further, as different operation patterns are used for driving the operation member depending on the kinds of images displayed and/or the location of the operation member, it is possible to realize an operation switch capable of producing a plurality kinds of mechanical reactive forces using a single operation member. This enables reduction of the number of components.

### BRIEF DESCRIPTION OF THE DRAWINGS

FIG. 1 is a structural diagram schematically showing a user interface device according to a first embodiment of the present invention;

FIG. 2 is a plan view showing the user interface device of FIG. 1, with the upper surface and the display screen removed;

FIG. 3 is a side view showing the user interface device of FIG. 2 with the side surface removed;

FIG. 4 is a functional block diagram for a haptic interface device used in the first embodiment;

FIGS. 5A and 5B are conceptual diagrams showing operation patterns for use with an operation member corresponding to a basic selection screen image shown on a screen in the first embodiment;

FIG. 6 is a diagram showing an example of a magnification factor selection screen image shown on a screen in the first embodiment;

FIG. 7 is a conceptual diagram showing an operation pattern for use with an operation member corresponding to a magnification factor selection screen image shown on a screen in the first embodiment;

FIG. 8 is a conceptual diagram showing an operation pattern for use with an operation member corresponding to a basic selection screen image having an input switch in the first embodiment;

FIGS. 9A, 9B, 9C, and 9D are conceptual diagrams showing modified examples of display screens usable in the first embodiment;

FIGS. 10A and 10B are conceptual diagrams showing modified examples of an operation switch device usable in the first embodiment;

FIG. 11 is a structural diagram schematically showing a user interface device according to a second embodiment of the present invention;

FIG. 12 is a plan view showing the operation switch device of the user interface device of FIG. 11 with a display screen removed;

FIG. 13 is a front view showing the operation switch device of FIG. 12 with an operation member drive control means removed;

FIG. 14 is a side view showing the operation switch device of FIG. 12 viewed from the left side of FIG. 12;

FIG. 15 is a diagram showing an example of a zoom selection screen image shown on a screen in the second embodiment;

FIG. 16 is a structural diagram schematically showing a user interface device according to a third embodiment of the present invention;

FIG. 17 is a front view showing the operation switch device of FIG. 16;

FIG. 18 is a diagram showing an example of a selection screen image displayed in a conventional copying machine;

FIG. 19 is a diagram showing alignment of an image display section and an operation switch in a conventional waveform observing apparatus;

FIG. 20 is a structural diagram schematically showing a modified example of a user interface device in the first embodiment;

FIG. 21 is a structural diagram schematically showing a modified example of a user interface device in the second embodiment; and

FIG. 22 is a structural diagram schematically showing another modified example of a user interface device in the second embodiment.

### DESCRIPTION OF THE PREFERRED EMBODIMENTS

In the following, preferred embodiments of the present invention will be described based on the accompanied drawings.

### Embodiment 1

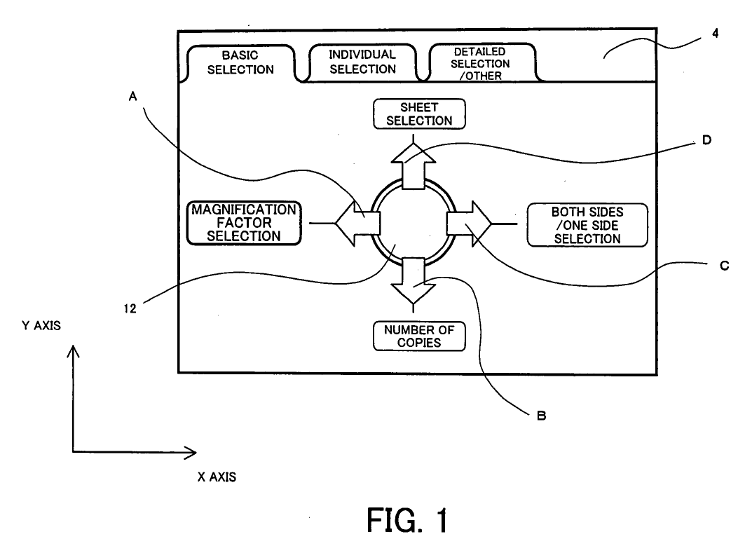

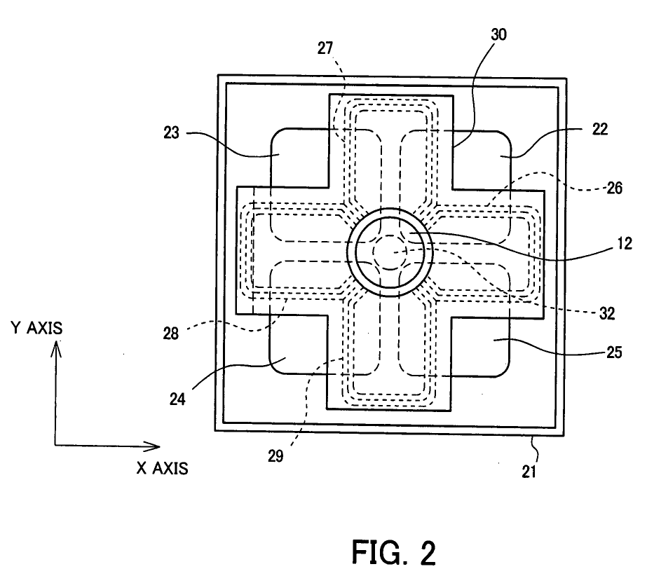

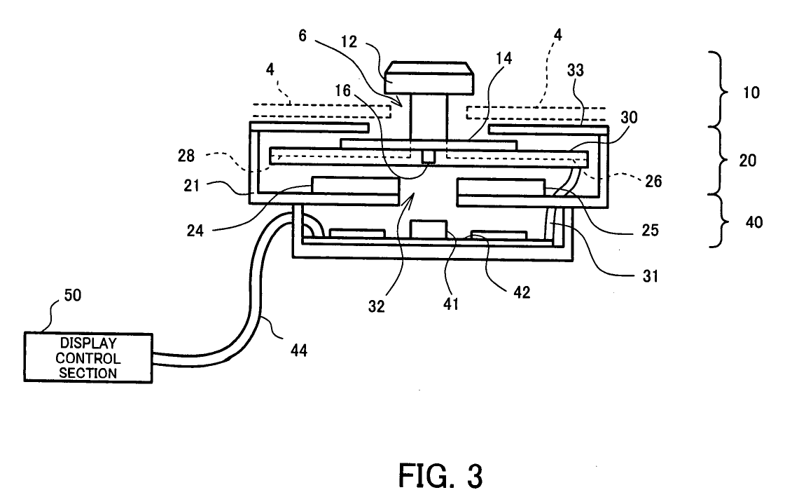

FIG. 1 is a schematic diagram showing a structure of a user interface device according to a first embodiment of the present invention. FIG. 2 is a plan view showing the user interface device of FIG. 1 with the displayed image removed. FIG. 3 is a side view showing the user interface device of FIG. 2. In FIGS. 2 and 3, upper and side panels of the main body of the device are not shown so as to clearly depict the internal structure of the user interface device. The structure of this embodiment will be described with reference to these drawings.

A user interface device in this embodiment comprises an operation switch device 2 for operation by a user and a display screen 4 for displaying an image. The user interface device is incorporated into an image processing device (not shown). As is clear from FIG. 1, which shows a displayed image, the information processing device here is a copying machine.

An opening 6 is formed in the substantial center of the display screen 4. An operation member 12 of the operation switch device 2 passes through the opening 6 to be connected to the main body of the operation switch device 2, which is accommodated inside the information processing device below the display screen 4. That is, the operation switch device 2 projects above the display screen 4. Although the device in this embodiment is intended to be operated by a user with his or her finger placed on the top of the operation member 12, a user may be able to carry out operations by gripping a more largely projecting operation member 12. Alternatively, the operation member 12 may instead be assembled such that the top surface of the operation member 12 and the surface of the display screen 4 together form a flat surface.

As shown in FIG. 3, the operation switch device 2 in this embodiment can mainly be divided into an operation section 10, a driving section 20, and a control section 40. The operation section 10 has an operation member 12, described above. A light emitter 16 is attached to the substrate 14 at the center of the surface thereof, for emitting light in a direction away from the operation member 12, though for simplification the light emitter 16 is not shown in FIG. 2.

The driving section 20 electromagnetically drives the operation member 12 so as to convey a reactive force to the user operating the operation member 12. The driving section 20 has magnets 22, 23, 24, 25 which are arranged so as to form alternate polarities on the inside bottom surface of the case 21. The magnets 22 to 25 are polarized in the thickness direction of the device 2 so that a magnetic field is generated between the adjacent magnets.

Coils 26, 27, 28, 29 and a frame 30 in which the coils 26 to 29 are mounted are mounted in the space above the magnets 22 to 25 such that each coil 26 to 29 is located between adjacent magnets 22 to 25. By supplying a current in the predetermined direction to the coils 26 and 28, which are arranged parallel to each other in the X direction in the magnetic field, according to Fleming's Left Hand Rule, the movable frame 30 is driven in the Y-axial direction. Likewise, by supplying a current to the coils 27 and 29 which are arranged parallel to each other in the Y direction, the frame 30 is driven in the X-axial direction. That is, application of a current to only one of the pairs of coils can drive the frame 30 in a one-dimensional direction, while application of a current to both of the coil pairs can drive the frame 30 in a two-dimensional direction. As described above, the driving section 20 has a structure having a frame 30 capable of rotation inside the case 21.

A substrate 14 of the operation section 10 is mounted on the frame 30, which has an opening 32 formed at the center thereof so as not to cover the light emitter 16 attached to the substrate 14.

A control section 40 (described later) supplies a current to the coils 26 to 29 via a signal line 31 to thereby control driving of the driving section 20 to move the frame 30. The operation member 12 mounted on the frame 30 moves together with the frame 30 moving. The driving section 20 electromagnetically drives the operation member 12 under control by the control section 40 so as to convey a reactive force to the user. The driving section 20 can be realized using, for example, a two-dimensional actuator disclosed in Document 4 (Japanese Patent Laid-open No. 2000-330688).

Light from the light emitter 16 that passes through the opening 32 is received by the photo-sensor 41. Because the photo-sensor 41 detects an amount of movement of the operation member 12 based on the incident direction of the detected light, the opening 32 must be large enough so as not to block light passage within the range where the operation member 12 can move. The photo-sensor 41 may alternatively detect the amount based on a light irradiation position and/or a light amount. It should be noted that, although a range where the operation member 12 can move is identical to a range where the photo-sensor 41 can detect light, in practice, the range where the operation member 12 can move is defined based on the size of the open area or opening 6 formed on the surface 33 of the enclosure.

The control section 40 comprises a control substrate 42 bearing a control circuit formed thereon for controlling driving of the driving section 20, and the photo-sensor 41, described above, formed on the control substrate 42. The photo-sensor 41 detects light from the light emitter 16 to thereby detect the position of the operation member 12 within the range where the operation member 12 can move, as described above. That is, a position detection means in this embodiment comprises a photo-sensor 41 for detecting light from the light emitter 16 and a detection circuit (not shown) formed on the control substrate 42, for detecting the position of the operation member 12 based on the amount of movement of the light, which is detected by the photo-sensor 41.

A signal line 44 is connected to the control substrate 42 for data exchange with respect to the display control section 50. The control section 40 controls driving of the driving section 20 based on the positional relationship between a displayed image and the operation member 12 to thereby drive the operation member 12, so that various kinds of operating feeling can be conveyed to the user operating the operation member 12.

Because the operation switch device 2 constructed as described above is incorporated into an information processing device (not shown) for use together with other electric and/or electronic components and so forth in this embodiment, the enclosure of the operation switch device 2, including the case 21, is preferably formed using a magnetic shielded member, such as a silicon steel panel, or the like. However, in this embodiment, the upper panel of the case 21 which forms the surface 33 may be removed so that the display screen 4 may additionally function as the upper panel of the case 21.

Although the device in this embodiment is intended to be used with a display screen 4 installed substantially horizontally, the device may be used with a display screen 4 installed uprising. In this case, the driving section 20 must drive the operating member 12 in consideration of the weight of the frame 30 and the operation section 10 under control by the control section 40. It is desirable that the frame 30 be connected on its four sides to the case 21 by means of an elastic member such as a rubber or a spring in order to support the moving components while not being driven.

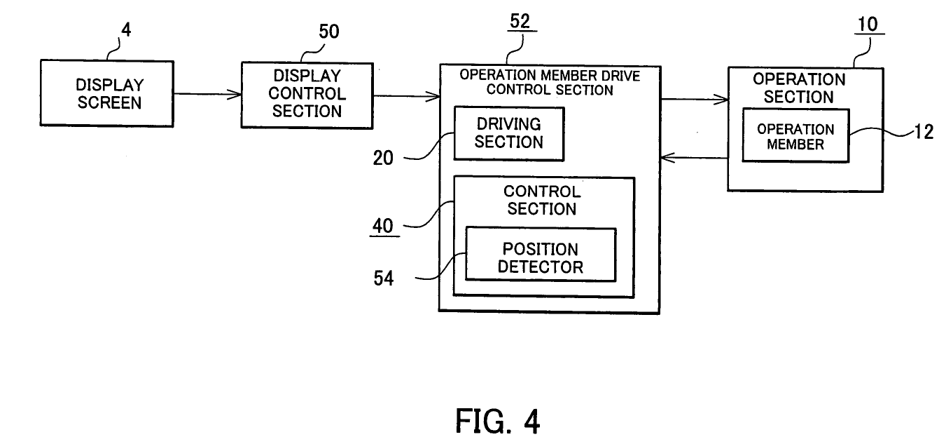

FIG. 4 is a functional block diagram showing a structure of a haptic interface device in this embodiment, in which the same components as those described earlier are identified by the same reference numbers.

Specifically, FIG. 4 shows a display screen 4, a display control section 50, an operation member drive control section 52, and an operation section 10. The display control section 50 controls displaying of an image on the display screen 4. The operation member drive control section 52 comprises the driving section 20 and the control section 40, both described above, and drives the operation member 12. The control section 40 incorporates a position detector 54 which comprises a photo-sensor 41 and a detection circuit and detects the position of the operation member 12 in the display screen 4.

Here, the display control section 50 notifies the state of display to the operation member drive control section 52. As operation patterns for the operation member 12 are registered in advance in the operation member drive control section 52 so as to correspond to an image displayed on the display screen 4, the operation member drive control section 52 drives the operation member 12 according to an operation pattern associated with the state of display notified by the display control section 50.

The operation member drive control section 52 notifies the display control section 50 of the detected motion and position of the operation member 12, so that the display control section 50 changes images to display according to the information supplied from the operation member drive control section 52. Note that “to change images” means both to replace the current image by another image and to show the image in a position displaced (or moved) from its current position.

Also, “the state of display” means whether or not any image is shown on the display screen (display/non-display state) and, if any, which image is shown, and so forth. No image is shown in a suspension mode. Here, the kind of image to be displayed by the display control section 50 can be specified using identification information such as image identification information or the like, and the display/non-display mode can be identified based on identification information of a display mode (such as a suspension mode). The display control section 50 sends this identification information as “the state of display”.

An “operation pattern” for the operation member 12 specifies a movable range and the manner of driving, as will be obvious from the following description. As described above, a movable range of the operation member 12 is determined based on the open region or opening 6 formed on the surface 33 of the enclosure. “Specification of a movable range” here means determination of a movable range so as to correspond to a displayed image. For example, in the example of FIG. 1, because the operation member 12 is expected to be operated only in four directions (up, down, right, and left in the drawing), the operation member drive control section 52 controls driving such that the operation member 12 is allowed to be operated only in these four directions so as to correspond to a displayed image, even though the operation member 12 can structurally be driven in any two-dimensional direction.

Here, in the example of FIG. 1, suppose that the user moves the operation member 12 leftward to thereby select “Magnification Factor Selection”. Then, the operation member drive control section 52 controls so as to convey a reactive force to the user so that the user can feel clicking as selection confirmation. Alternatively, the operation member drive control section 52 may control to cause vibration.

In order to create the clicking feeling or cause vibration, the operation member 12 is driven according to a predetermined driving pattern. “A type of operation pattern” here means a pattern according to which the operation member 12 is driven. Operation patterns are registered in advance in the operation member drive control section 52 as specification information for use by the operation member drive control section 52 to drive the operation member 12. Specification information is defined so as to correspond to each display image or relationship between each display image and the position of the operation member 12.

In the following, operation in this embodiment will be described.

Suppose that the image of FIG. 1 is shown on the display screen 4. In this example, Sheet “Basic Selection” is selected from among three kinds of sheets including “Basic Selection”, “Individual Selection”, and “Detail Selection/Other”. In the basic selection screen image, labels of selection items including “Magnification Factor Selection”, “Number of Copies”, “Both Sides/One Side Selection”, and “Sheet Selection” are shown in four directions (left, below, right, above) around the operation member 12. Therefore, the operation member drive control section 52 is expected to control driving of the operation member 12 such that the operation member 12 is operated in only four directions (left, down, right, up) indicated by arrows A, B, C, and D in the drawing.

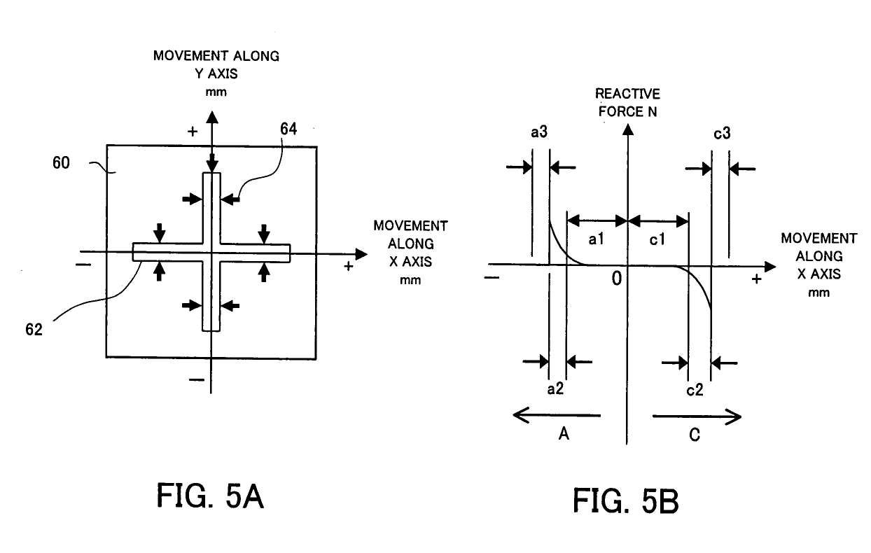

FIGS. 5A and 5B are conceptual diagrams schematically showing specification information for the example of FIG. 1. Specifically, FIG. 5A shows a range where the operation member 12 can move, and FIG. 5B shows a driving pattern according to which the operation member 12 is driven. In FIG. 5A, a rectangular structurally movable range 60 corresponds to a range where the operation member 12 can be structurally driven as described above, and a cross-shaped specified movable range 62 corresponds to a range where the operation member 12 can move corresponding to a displayed image based on specification information.

Initially, the operation member 12 is located at the center where the X and Y axes intersect each other. The operation member drive control section 52 controls driving of the operation member 12 such that a user can operate the operation member 12 within the specified movable range 62 as shown in FIG. 5A. This will be more specifically described below.

That is, the position detector 54 always detects the location of the operation member 12 within the structurally movable range 60. When it is detected that the operation member 12 is located within the specified movable range 62, the operation member drive control section 52 applies reactive forces to be described later with reference to FIG. 5B to the operation member 12. However, when it is detected that the operation member 12 is attempting to depart from the specified movable range 62, the operation member drive control section 52 applies a stronger reactive force in the direction indicated by the arrow 64 to the operation member 12 in order to block the operation member 12 departing from the specified movable range 62. In this manner, the operation member drive control section 52 controls the operation member 12 so as to move only within the specified movable range 62.

It should be noted that, although eight arrows 64 are shown along the border between the structurally movable range 60 and the specified movable range 62 in FIG. 5A, in practice, a reactive force is applied at any point along the border. That is, strictly speaking, the specified movable range 62 is determined by connecting points at which a reactive force indicated by the arrow 64 is applied to the operation member 12.

Here, suppose that the user moves the operation member 12 in the direction of the arrow A in order to select “Magnification Factor Selection”. In response to this operation, a reactive force is applied to the user, as described below with reference to FIG. 5B.

The direction of the arrow A corresponds to movement in a minus direction along the X-axis, as correlated in FIG. 5B. While operating the operation member 12 so as to move within the range a2, the user does not feel any reaction. However, when the user keeps operating the operation member 12 beyond the range al into the range a2, a reactive force begins to gradually be caused which the user feels as resistance. It is appreciated from FIG. 5B, in which a positive reactive force is caused relative to a movement in the minus direction along the x-axis, that the user will feel the reactive force as resistance.

While the operation member 12 remains in the range a2, a display region associated with “Magnification Factor Selection” is shown in reverse display in order to emphasize that “Magnification Factor Selection” is a current candidate for an item to be selected. Specifically, upon detection that the operation member 12 is in the range a2, the position detector 54 sends the positional information concerning the operation member 12 to the display control section 50, which, in turn, controls based on the received positional information so as to display the display region associated with the “Magnification Factor Selection” in reverse display.

It should be noted that although reverse display is employed so that an item selected by the user, that is, “Magnification Factor Selection” here, is displayed differently from other items in this embodiment, the present invention is not limited to reverse display and blinking or highlighting, for example, may also be employed. Alternatively, the manner of displaying items which are not selected, rather than the selected item, may be changed so that the selected and not-selected items are displayed in a different manner from each other. For example, the not-selected items may be displayed less clearly, or darker.

When the user keeps operating the operation member 12 so as to move beyond the range a2 into the range a3, the maximum reactive force is first applied to the operation member 12 at the border between these ranges and, thereafter, the reactive force is rapidly waned until the user feels no resistance. With this arrangement, the user obtains the feeling that the switch has been pressed reliably, which may be similar to the clicking feeling. Further, any sound, such as “click”, which may cause the user to obtain the clicking feeling may be caused. This arrangement, similar to the clicking feeling, can help the user to conceive the idea that the switch has been depressed. When the operation member 12 has been moved to the range a3, the selection is completed.

Notified by the operation member drive control section 52, the display control section 50 knows that the operation member 12 have entered the range a3. Then, the display control section 50 switches to show a multiplication factor selection screen image and then notifies the operation member drive control section 52 of the switch.

It is desirable, after completion of item selection, that the operation member 12 be driven so as to return to the original point, rather than continuously subjected to a reactive force, as shown in FIG. 5B. Therefore, upon completion of item selection, the operation member drive control section 52 changes the specification information of FIG. 5B to specification information for applying no reactive force and automatically returning the operation member 12 to the original point, and begins driving the operation member 12 according to an operation pattern defined by the latter specification information. As described above, the operation member drive control section 52 can exhibit different reactive forces relative to the same display image depending on the situation. Further, making sounds corresponding to the operation pattern can help the user to ascertain completion of operation.

After returning or without returning the operation member 12 to the original point, the operation member drive control section 52 controls so as to move the operation member 12 to the initial position for the magnification factor selection screen image to be subsequently displayed.

It should be noted that, although a case in which the operation member 12 is moved in the direction of the arrow A is described above, identical operation to the above described operation is applied to the operation member moving in, for example, the direction of the arrow C when the operation member 12 is located in the ranges c1, c2, and c3, except that the directions of operation and a reactive force are reversed. Likewise, identical operation to that which is applied in the case with movement in the direction of the arrow A or C is applied to the operation member 12 moving in the direction of the arrow B or D along the Y-axis except that X should be replaced with X for interpretation.

As described above, by controlling driving of the operation member 12 so as to correspond to an image displayed, it is possible to have the user operate according to the displayed image. Moreover, the user can perform operation according to the image displayed with his or her eyes kept directed on the display screen of the operation member 12 because the operation member 12 is provided within the display screen 4 in this embodiment. In this way, it is possible to provide a user interface device which allows a user to operate without imposing extra strain on his or her eyesight and produces superior operating feeling by conveying clicking feeling, or the like, to the user.

In this embodiment, which employs the specification shown in FIG. 5B, data input is confirmed by a user's moving the operation member 12 into the range a3. This arrangement can eliminate the need to provide a separate mechanism for input confirmation. Alternatively, any input confirmation mechanism may be separately provided, such as a pressure sensor or the like mounted at the top of the operation member 12, to form an input switch. In this case, the control section 40 of the operation member drive control section 52 must have means for detecting operation of the input switch, while the ranges a3, c3 in FIG. 5B are unnecessary.

Although the operation member 12 departing from the specified movable range 62 is blocked using only strong reactive forces represented by the arrows 64 in the above, it may be constructed such that the user may additionally be warned according to a predetermined operation pattern when the operation member 12 is located at the border between the structurally movable range 60 and the specified movable range 62, through, for example, vibration or corresponding sounds to rouse his or her attention. While the reactive force represented by arrows 64 creates the sense of resistance for the user in response to his or her operation, the operation pattern such as vibration creates operating feeling for the user in response to the position of the operation member 12.

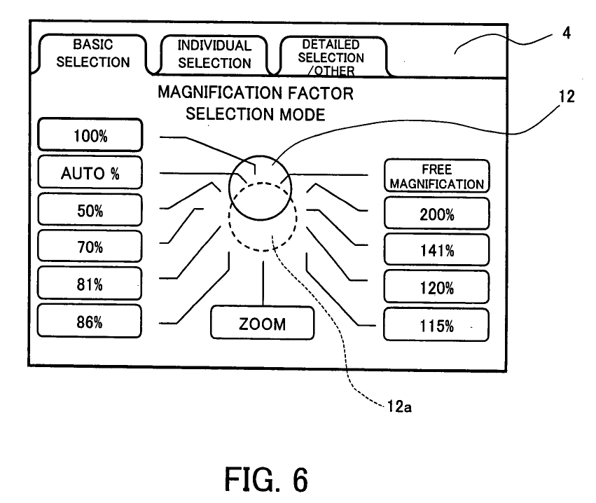

FIG. 6 is a diagram corresponding to FIG. 1 and showing an example of a magnification factor selection screen image to be displayed upon selection of the “Magnification Factor Selection” for selecting a magnification factor. Functional hierarchies implemented by a copying machine, which can be seen in FIGS. 1 and 6, can be switched by operating the operation member 12. When a touch-panel input mechanism is provided to the display screen 4, the hierarchies can be switched to present a different sheet (a display image) through direct touch on the display screen 4.

Assume that a position where the operation member 12 is located while not being driven by the control section 40 is determined as an original point of the operation member 12. On the basic selection screen image of FIG. 1, the original point is the initial position of the operation member 12 and the operation member 12 must be movable in four directions (up, down, left, and right) relative to the initial position as a center. Meanwhile, on the magnification factor selection screen image of FIG. 6, a position deviated from the original point is the initial position of the operation member 12 and the operation member 12 must be movable along the circumference of the circle with the original point at the center.

The position corresponding to magnification “100%” is determined as an initial position of the operation member 12 in this embodiment, and the operation member 12 is shown at the initial position in FIG. 6. Note that the operation member 12a represents an operation member 12 at the original point.

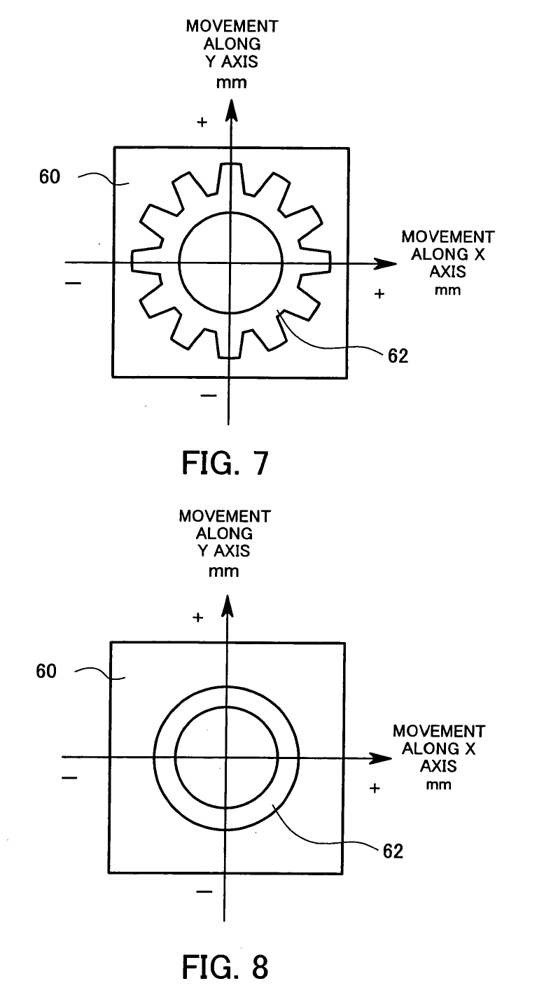

FIG. 7 shows a range where the operation member 12 can move, including a structurally movable range 60 where the operation member 12 can structurally be driven and a specified movable range 62 where the operation member 12 can substantially move.

As is obvious from comparison between FIGS. 6 and 7, the specified movable range 62 is defined by combination of a circular region and a region having projections each corresponding to a display position of each selection item, including “100%”, “auto %”, or the like. That is, under control of the control section 40 based on the specification information shown in FIG. 7, the user can rotate the circular region in any direction within the specified movable range 62 to thereby set the operation member 12 at a position corresponding to a desired magnification factor, or the like. Because it is known, based on the relationship between the original point and the operation member 12, which selection item the operation member 12 is currently positioned to correspond to, the currently selected item is rendered to be shown in a reverse display in this embodiment.

The user confirms, by viewing, that the desired selection item is in reverse display and then moves the operation member 12 toward the selection item in reverse display to thereby select the desired magnification factor, or the like. It may be constructed so that a reactive force which is described in connection with the range a2 in FIG. 5B may be applied relative to the linear movement of the operation member 12 from the position with a projection along the circumference to the selection item in reverse display, to thereby confirm item selection.

Alternatively, an input switch may be provided at the top of the operation member 12 for confirmation of item selection, as described above. In this case, an operation pattern for the operation member 12 can be set as shown in FIG. 8. It should be noted that, although arrows for reactive forces as shown in FIG. 5A are not shown in FIG. 7, different reactive forces can be applied depending on displayed images or methods for selection confirmation.

Here, the display screen 4 does not always show an image. For example, a suspension mode function is available, in which images on the screen are all temporarily erased for protection of a liquid crystal screen after a predetermined period of time with no image input and that state is maintained until next input of any information. Therefore, when the operation member drive control section 52, which is notified of the current state of display by the display control section 50, as described above, knows that a suspension mode is effected and that no image is shown, the operation member drive control section 52 sets the specified movable range 62 so as to be identical to the structurally movable range 60 whereby an operation pattern for the operation member 12 is switched to an operation pattern for a non-display mode.

Thereafter, when the operation member 12 is operated by a user to move in any direction, the operation pattern for a non-display mode is switched to an operation pattern for the display image which was shown before transition to the suspension mode. Further, having been notified by the operation member drive control section 52, the display control section 50 displays the image which was shown before transition to the suspension mode.

It should be noted that, although the specified movable range 62 is set identical to the structurally movable range 60 in a non-display mode in this embodiment, the present invention is not limited to this configuration. Alternatively, different operation patterns may be used for a non-display mode depending on a cause which triggers the non-display state. For example, the operation member 12 may be fixed at the original point.

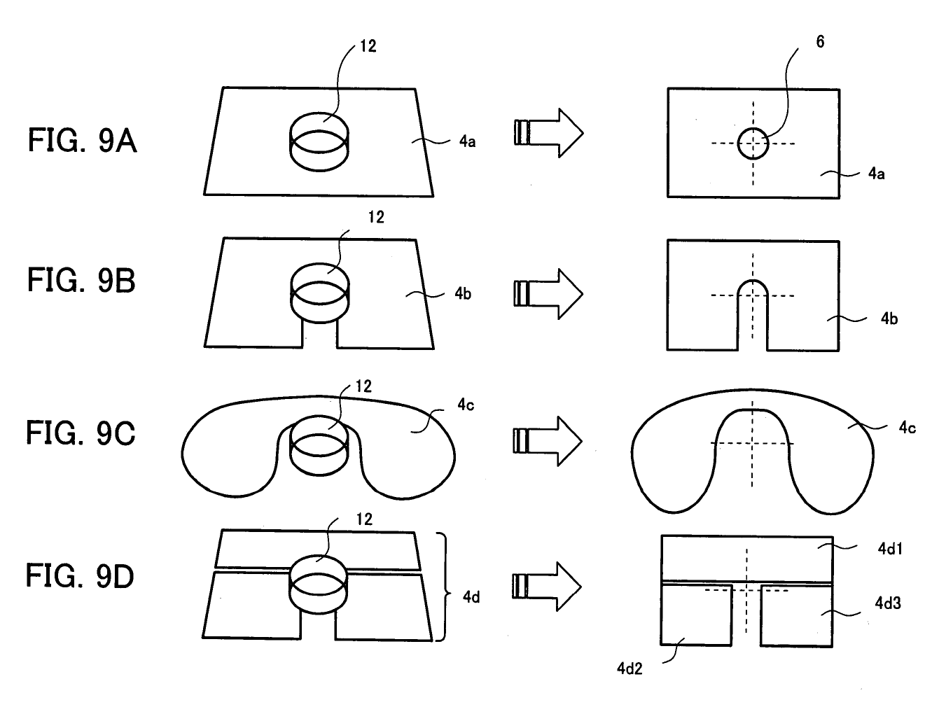

FIGS. 9A through 9D are conceptual diagrams showing examples of a modified display screen 4 usable in this embodiment. The respective graphics of FIG. 9 show the display screen 4 combined with, and separated from, the operation member 12.

FIG. 9A shows a typical structure, as employed in the structure described above, in which an opening 6 is formed at a predetermined position on the display screen 4a. The display screen 4a of FIG. 9A can display an image in all directions around the operation member 12, and this structure requires separation of the operation member 12 from the main body of the operation switch device to assemble the device.

FIG. 9B shows a structure in which the display screen 4b is partly cut off so that the device can be assembled without separating the operation member 12 from the main body of the operation switch device. FIG. 9C shows a structure in which the display screen 4b is partly cut off and the display screen 4 has a desired shape defined by a curving line. FIG. 9D shows a structure in which independent rectangular display panels 4d1, 4d2, 4d3 are arranged close to one another, thereby forming the display panel 4d.

The structures of FIGS. 9B to 9D allow assembly without separation of the operation member 12 from the main body of the operation switch device, though the use of these structures tends to be limited to cases in which an image to be displayed is determined in advance because the range for displaying an image is partly limited.

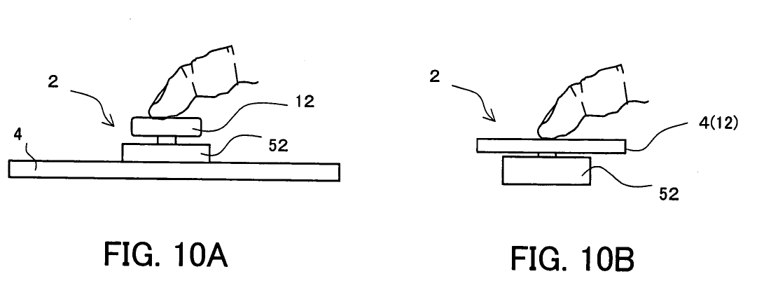

FIGS. 10A and 10B show modified examples of an operation switch device 2 in this embodiment. Whereas the above-described user interface device requires an opening 6 formed on the display screen 4, the shown example does not. FIG. 10A shows a structure in which the operation switch device 2 is mounted on the display screen 4. In this structure, a signal line connecting the operation switch device 2 and the display control section 50 runs on the display screen 4. FIG. 10B shows a structure in which the display screen 4 also functions as the operation member 12 of the operation switch device 2. In this structure, the operation member drive control section 52 directly drives the display screen 4 serving as an operation member 12.

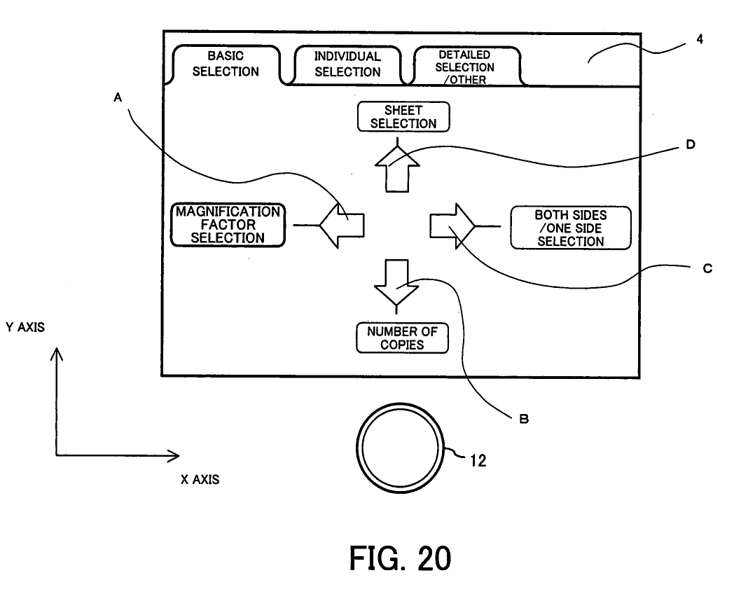

It should be noted that a structure having an operation member 12 provided within a display region of the display screen 4 is described in the above, the present invention is not limited to this structure. Alternatively, an operation member 12 may be provided in the vicinity of an operation member 12, as shown in FIG. 20.

The structure of the example of FIG. 20 may be constructed such that the operation member 12 is controlled by the operation member drive control section 52 so as to be operated only in four (up, down, left, and right) directions corresponding to the selection items shown in the display screen 4. In addition, similar to the above-described example, in response to a user's moving the operation member 12 leftward to thereby select “Magnification Factor Selection”, the operation member drive control section 52 may apply a reactive force to the user to thereby convey clicking feeling. Alternatively, it may be constructed such that vibration is caused.

### Embodiment 2

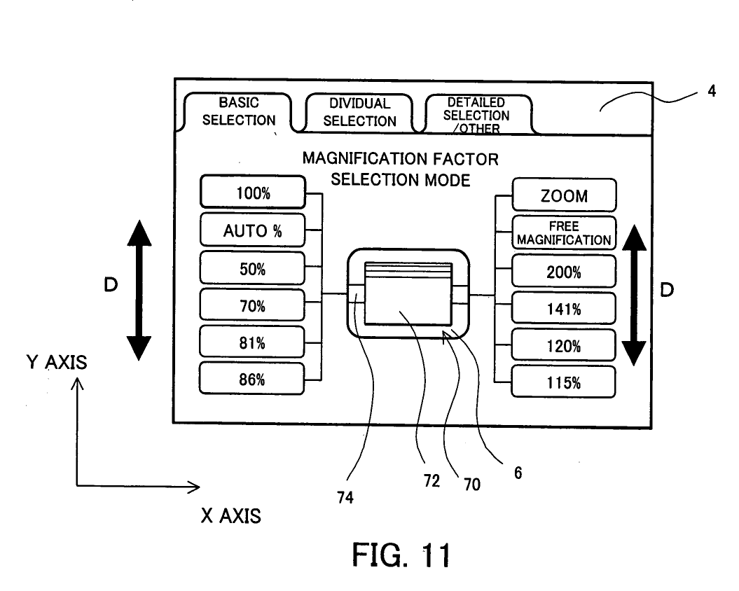

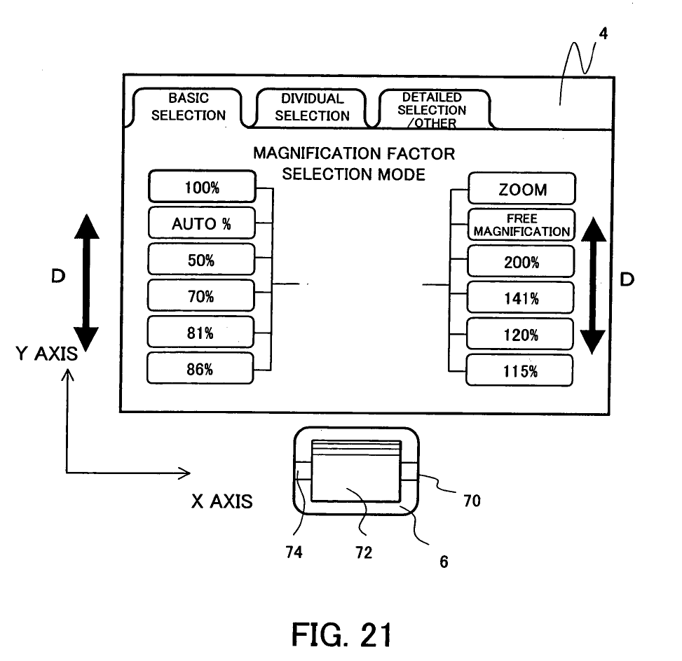

FIG. 11 is a schematic diagram showing a structure of a user interface device according to a second embodiment of the present invention. The user interface device in this embodiment comprises a display screen 4 and an operation switch device 70 which has a structure different from that in the first embodiment. The user interface device is incorporated into an image processing device (not shown). It should be noted that the operation switch device 70 may be provided in the vicinity of the display screen 4, as shown in FIG. 21.

It is known from FIG. 11, which shows an image displayed, that the information processing device here is a copying machine and it is also known in view of the displayed content that FIG. 11 corresponds to FIG. 6.

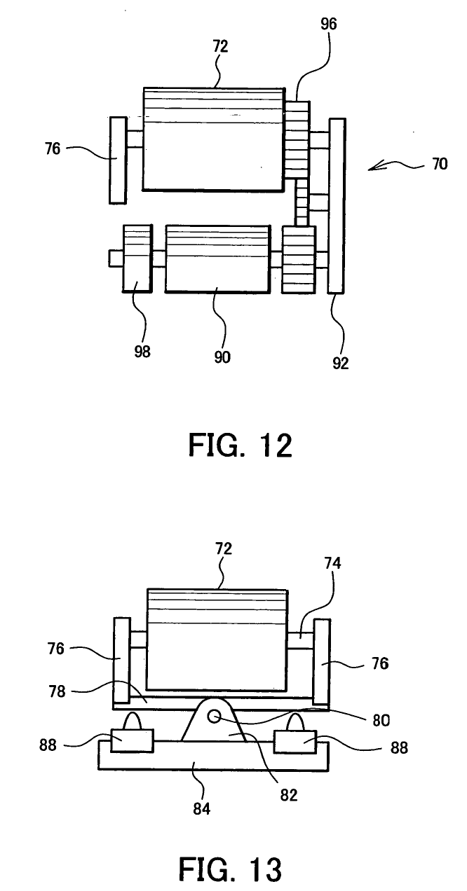

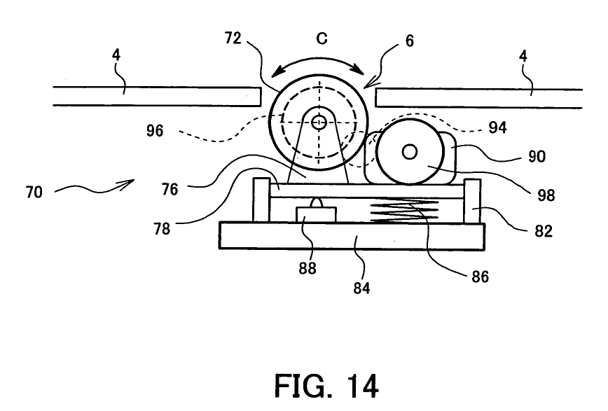

FIG. 12 is a plan view showing the operation switch device 70 of the user interface device of FIG. 11 with the display screen 4 removed. FIG. 13 is a front view showing the operation switch device 70 with an operation member drive control section, such as an encoder, removed. FIG. 14 is a side view of the operation switch device 70 of FIG. 12 viewed from the left side in FIG. 12.

As is obvious from these drawings, the operation switch device 70 is driven to rotate around an axis parallel to the X axis. The rotational direction of the operation member 72 is indicated by the arrow C. A user rotates the operation member 72 using his or her finger in either direction.

An opening 6 is formed on the display screen 4, which has a shape corresponding to that of the operation member 72 so that the operation member 72, supported by the axis 74 and the arms 76, partly projects through the opening 6 above the screen. The arms 76 are mounted on a movable block 78, which is in turn supported at the center thereof by a pivot 80 and a bearing 82 and fixed to the pedestal 84. A coil spring 86 is provided between the movable block 78 and the pedestal 84, serving as a means for balancing the movable block 78. Push switches 88 are provided on the pedestal 84 at points corresponding to both ends of the movable block 78.

As an operation member drive control means for controlling driving of the operation member 72 and as a means for detecting an amount of operation of the operation member 72 caused by a user, the structure described below is provided. That is, a drive motor 90 drives to rotate the axis 74 via gears 92, 94, 96 to thereby drive the operation member 72. Further, an encoder 98 is attached to the axis of the drive motor 90 to count rotation detection pulses from the encoder 98 to thereby detect the amount of rotation.

In this embodiment, in which an amount of rotation of the operation member 72 is detected, “an amount of operation” is equal to “an amount of rotation” or an angle of rotation defined based on the amount of rotation. As the operation member 72 additionally moves in the z-axial direction while being pressed, detection of the amount of operation includes detection of the amount of this downward movement of the operation member 72, though a specific amount thereof is not obtained here.

Note that a display control means and electric wires for connecting the push switch 88 and/or the display control section are not shown in FIGS. 12 to 14. The functional block diagram referred to in this embodiment is identical to FIG. 4, except that the position detection section is replaced by a means for detecting the content of operation, which is realized using an encoder 98 or the like.

In the following, operation of the thus structured user interface device in this embodiment will be described.

FIG. 11 shows a magnification factor selection screen image to be shown upon selection of “Magnification Factor Selection” in the basic selection screen image, with “100%” selected as a selection candidate in the initial state of the magnification factor selection screen image. The item which is selected as a selection candidate, that is, “100%” here, is shown outlined by a thicker line, though it can be displayed in reverse display, similar to the first embodiment.

A user rotates the operation member 72 using his or her finger to thereby select items. As the operation member 72 is operated to rotate, a selection candidate is caused to shift from one to the other in correlation with the direction of rotation of the operation member 72. Specifically, the display control section 50 changes the state of display of each selection item based on the amount of rotation of the operation member 72, which is known based on the number of rotation detection pulses from the encoder 98. A selection candidate can shift among selection items shown in FIG. 6, including “100%” and “115%”, in the directions indicated by the arrows D. Specifically, when the operation member 72 is operated for downward rotation in the drawing (the minus direction along the y-axis), a selection candidate shifts from “100%”, “auto %”, . . . “86%”, “zoom”, and so forth, while, when the operation member 72 is operated for upward rotation in the drawing (the plus direction along the y-axis), a selection candidate shifts in a reverse direction, that is, from “100%”, “115%”, “120%”, and so forth.

In brief, a selection candidate in reverse display sequentially shifts every rotational movement of the operation member 72 by a predetermined amount, that is, a predetermined angle. In this embodiment, the operation member drive control section 52 drives the operation member 72 so as to convey a reactive force so that the user can conceive operating feeling, such as clicking (feeling that the operation progresses in a stepwise manner for rotation of every predetermined amount). In this way, the user can conceive operating feeling, or clicking, every time a selection candidate shifts and thus feel as if he or she operated a mechanical rotating roller switch. Further, any sound, such as “click”, may actually be caused together with a reactive force. This arrangement may help create the sense of more reality.

Referring to FIG. 11, as only twelve selection items are presented in the magnification factor selection screen image in this example, a reactive force may be applied at a relatively rough interval, such as a rotation angle of 15 to 30 degrees.

It should be noted that a rotational speed may be detected in addition to the amount of rotation so that a speed in which to shift the items to show in reverse display is changed according to the rotational speed of the operation member 72, and operating feeling is created according to the speed in which to shift the items to be shown in reverse display.

After setting a selection candidate at a desired item, the user presses the operation member 72 to confirm the input operation. With the pressing, the operation member 72 is elastically depressed together with the movable block 78, which in turn presses, on the bottom surface thereof, either one of the right and left push switches 88. By detecting either one of the push switches 88 being pressed, the operation member drive control section 52 recognizes the user's confirmation operation.

In this embodiment, the operation member 72 is mounted on a seesaw-type movable block 78, as described above. Therefore, it is possible, by consciously pressing one end of the movable block 78, to activate only one of the push switches 88 which corresponds to the pressed end. In this way, there can be provided an operation switch device capable of commanding regarding right and left directions.

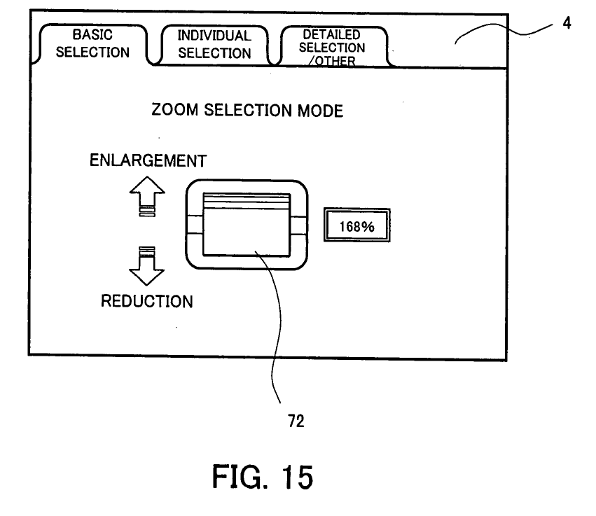

FIG. 15 shows an example of a zoom selection screen image to be shown upon selection of “Zoom” in the magnification factor selection screen image of FIG. 11. In FIG. 15, guidance for rotational direction and a current magnification factor are shown. Although an operation pattern for this display image is basically identical to that for the display image of FIG. 11, in the case where the magnification factor can be increased or decreased in units of 1%, creation of operating feeling at a smaller interval compared to that of FIG. 11 could effectively create the sense of more reality. Therefore, the operation member drive control section 52 may apply a reactive force at a relatively small interval, such as a rotation angle of about three degrees.

When the required copying condition is completely input, as described above, the user is requested to press a start button (not shown) to initiate a copying operation. Alternatively, a copying operation may begin in response to the depression of the operation member 72 or either one of the right and left ends of the operation member 72, according to a predetermined operation rule.

In this embodiment, an operation member 72 in the form of a rotating roller switch may be mounted on the display screen 4 to produce the same effect as that which would be produced in the first embodiment.

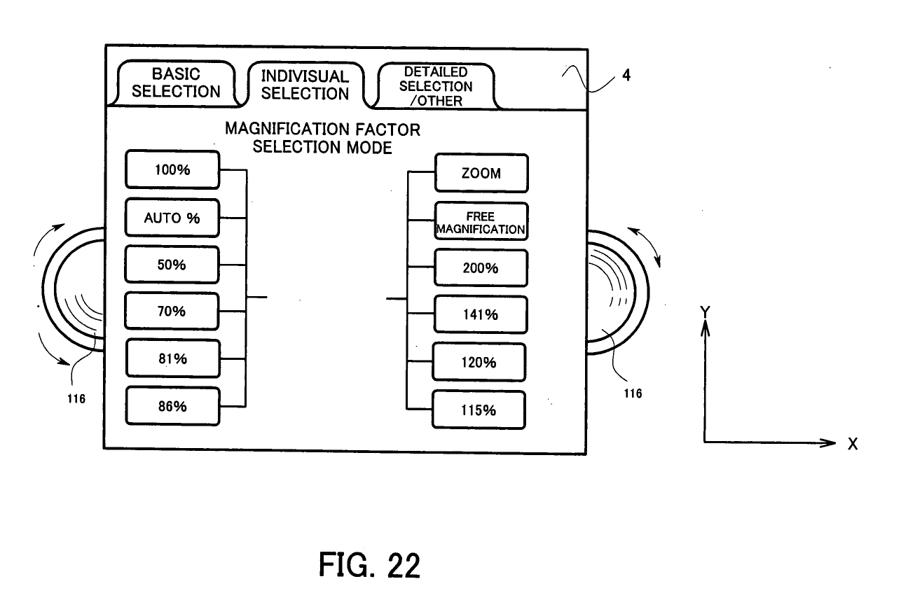

It should be noted that rotating roller switches may be arranged as shown in FIG. 22. In this example, the rotating roller switches are provided in the vicinity of the display screen 4 so as to each rotate around an axis perpendicular to the display screen. This arrangement allows use of a typical rectangular display panel and, therefore, a user interface device having a simple structure can be realized.

In addition, when an operation member 116 in the form of a rotating roller switch is arranged close to the selection items shown on a display screen, a user can select the items with the feeling as if he or she were directly operating the items, rather than the switch. In this case, the rotating roller switch may be provided either under or partly overlapping the display screen.

### Embodiment 3

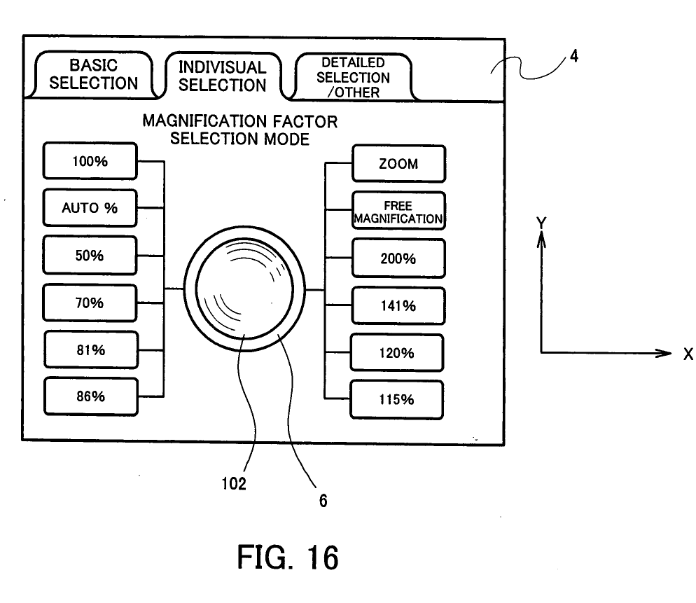

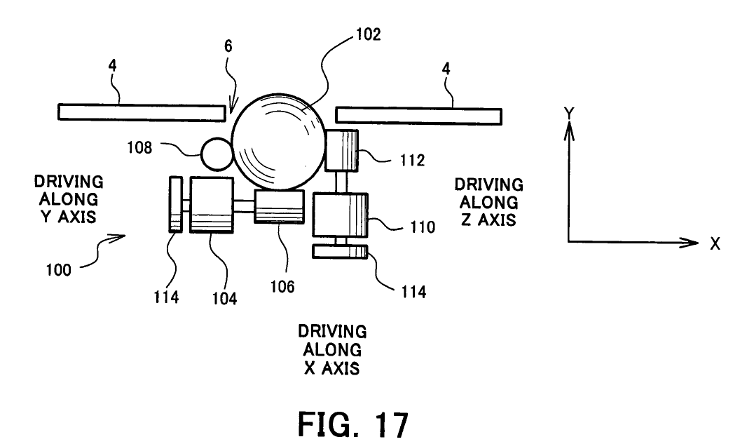

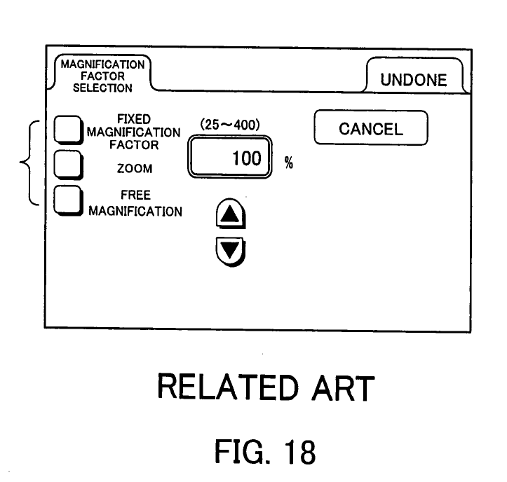

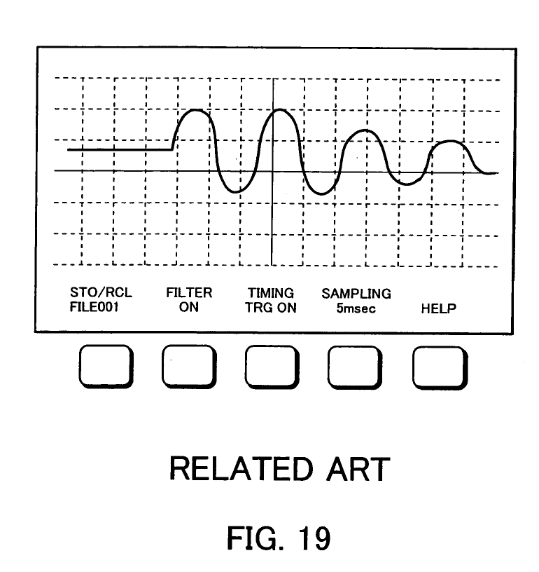

FIG. 16 is a schematic diagram showing a user interface device according to a third embodiment of the present invention. FIG. 17 is a front view of the user interface device of FIG. 16. Whereas a rotating roller switch is employed in the above described two embodiments, a track ball switch is employed as a spherical operation section 102 in this embodiment.

In this embodiment, an opening 6 is formed on the display screen 4, which has a shape corresponding to that of the operation section 102 so that the operation section 102 partly projects through the opening 6 above the screen 4.

The spherical operation section 102 is supported so as to be driven with three degrees of freedom by the operation member drive control means. Specifically, rotation around the x-axis is effected using the drive roller 106 attached to the tip end of the drive motor 104. The drive roller 106 is in contact with the operation section 102 with a predetermined contact pressure. Likewise, rotation around the y-axis is effected using the drive roller 108 attached to the tip end of a motor (not shown), which is in contact with the operation section 102. Rotation around the z-axis is effected using the drive roller 112 attached to the tip end of a drive motor 110, which is in contact with the operation section 102.

An amount of rotation of each of the drive rollers 106, 108, 112 is detected using a rotation detector 114 which is connected to the other end of each motor, with a rotation detector 114 for y-axis rotation being not shown. In this way, amounts of rotations in the respective directions are detected so that limitation of a movable range and/or determination of a reactive force according to an amount of movement as shown in FIGS. 5A and 5B can be achieved. It should be noted that, although a means for detecting an amount of movement of the operation section 102 differs from that in the second embodiment, operation of the display control section and the operation member drive control section is identical to that which is described in the above described embodiments and thus not described here.

In this embodiment, an operation section 102 in the form of a track ball switch may be mounted on the display screen 4 to produce the same effect as that which is produced in the first embodiment.

As described above, in the above-described embodiments, employment of a user interface which can produce mechanical reactive forces enables selection of a desired selection item from among a plurality of items through analog input operation, such as sliding, circulating, rotating, and so forth. This structure can overcome the drawbacks of a touch-panel method, that is, lack of operating feeling, attributed to its simple two-way operation of either pressing or not.

In addition, as an operation member is provided within a display region, that is, in a display screen, less movement of a user's sight line is required of the user while operating the device following an image displayed. This can minimize strain imposed on the user's eyesight.

It should be noted that although a liquid crystal panel is used as a display screen 4 in the above, the present invention is not limited to an LCD and any thin screen display means, including plasma, LED, and laser, may be applicable.

It should also be noted that although a copying machine is described as an example of an information processing device in the above, the present invention is not limited to this application and may be applicable to an input device for a vehicle navigation device. In this case, the user interface device can additionally be used for volume control and/or selection of broadcasting stations for audio devices as the display screen is usable not only for presentation of maps but also as an input screen for audio, CD, and AV devices.

The present user interface device is also usable, when formed in a smaller size, as an input device for portable phones, PDAs, and mobile devices. In addition, one display screen may have two or more operation members. The position of an operation member is not limited to the substantial center and the operation member may be mounted anywhere in the display screen.

What is claimed is:

1. A user interface device, comprising:
a display screen for displaying an image;
display control means for controlling so as to display an image on the display screen;
an operation member for being operated by a user; and
operation member drive control means for driving the operation member at least in a one-dimensional direction,
wherein
the operation member is mounted within, in the vicinity of, or partly overlapping a display region of the display screen.

2. The user interface device according to claim 1, wherein the operation member drive control means drives the operation member according to an operation pattern which corresponds to the image displayed on the display screen.

3. The user interface device according to claim 1, wherein the operation member drive control means conveys a variety of reactive forces to the user operating the operation member, depending on the image displayed on the display screen.

4. The user interface device according to claim 1, further comprises:
position detection means for detecting a position of the operation member within the display screen,
wherein
the operation member drive control means changes an operation pattern for the operation member according to the position of the operation member, which is detected by the position detection means.

5. The user interface device according to claim 4, wherein the display control means changes an image to be displayed on the display screen according to the position of the operation member relative to the image displayed on the display screen.

6. The user interface device according to claim 5, wherein the display control means switches images to be displayed on the display screen in response to an input confirmation operation performed by the user following the image displayed on the display screen.

7. The user interface device according to claim 6, wherein the operation member has an input confirmation mechanism.

8. The user interface device according to claim 1, wherein the display control means controls so as to display a selection item selected by the user using the operation member from among a plurality of selection items displayed on the display screen, in a manner different from a manner of displaying other selection items.

9. The user interface device according to claim 1, wherein the operation member drive control means drives the operation member in a non-display mode when no image is displayed on the display screen.

10. The user interface device according to claim 1, wherein the operation member is provided within the display screen and connected through an opening formed on the display screen to the operation member drive control means provided below the display screen.

11. The user interface device according to claim 1, wherein the operation member and the operation member drive control means are provided on the display screen.

12. The user interface device according to claim 1, wherein the display screen additionally functions as the operation member.

13. The user interface device according to claim 1, wherein the operation member drive control means drives the operation member with at least two degrees of freedom.

14. The user interface device according to claim 13, wherein the operation member drive control means drives the operation member with freedom along a plane in a two-dimensional direction which is substantially parallel to the display screen serving as a reference plane.

15. The user interface device according to claim 1, wherein the operation member drive control means drives the operation member with freedom for
rotation around an axis in a first direction substantially parallel to the display screen serving as a reference plane,
rotation around an axis in a second direction substantially parallel to the reference plane and vertical to the first direction,
rotation around an axis in a third direction substantially vertical to the reference plane, or
rotation that is a combination of at least two types of rotation described above.

16. The user interface device according to claim 1, wherein the screen display means has a touch panel input mechanism.

17. The user interface device according to claim 1, further comprises:
detection means for detecting an amount of operation of the operation means,
wherein
the operation member drive control means changes an operation pattern for the operation member according to the amount of operation detected by the detection means.
